(19) United States
(12) Patent Application Publication
(10) Pub. No.: US 2006/0193526 A1
(43) Pub. Date: Aug. 31, 2006

(54) Video encoder with low complexity noise reduction

(76) Inventors: Jill MacDonald Boyce, Manalapan, NJ (US); Joan Llach, Princeton, NJ (US)

Correspondence Address: THOMSON LICENSING INC., PATENT OPERATIONS, PO BOX 5312, PRINCETON, NJ, 08543-5312, US

(21) Appl. No.: 10/563,711

(22) PCT Filed: May 28, 2004
(86) PCT No.: PCT/US04/17176

§ 371 Date: Jan. 6, 2006

Related U.S. Application Data
(60) Provisional application No. 60/485,891, filed on Jul. 9, 2003.

(51) Int. Cl. G06K 9/36

(52) U.S. Cl. 382/236

(57) ABSTRACT

Noise reduction is achieved during video encoding with low complexity by making use of the motion estimation decision sets for noise reduction. Motion estimation is performed N times (where N is integer) on each macroblock to yield N sets of motion estimation data, each set including a reference picture index and a motion vector. Typically, although not necessarily, each set of motion estimation data makes use of a different reference picture. For each macroblock, the N sets of motion estimation data are used to create a noise-reduced macroblock, which is then encoded.

### CROSS-REFERENCE TO RELATED APPLICATIONS

This application claims priority under 35 U.S.C. 119(e) to U.S. Provisional Patent Application Ser. No. 60/485,891 filed Jul. 9, 2003, the teachings of which are incorporated herein.

### TECHNICAL FIELD

This invention relates to video encoders for encoding (compressing) a video stream.

### BACKGROUND ART

Many applications require the compression (i.e., encoding) of a video stream to reduce bandwidth requirements. Encoding devices presently exist for performing video compression in accordance with several well-known compression techniques, such as MPEG, H.263, and H.264. Noisy video sequences have proven more difficult to compress using such standard video compression techniques than clean video sequences at a given bit rate. Noise reduction can occur as a pre-processing function applied prior to video compression. Under such circumstances, a noise reduction stage reduces the noise on a sequence of input pictures applied to an encoder that compresses the noise-reduced pictures

Prior noise reduction techniques include spatial and/or temporal filtering. Temporal filtering involves the application of a filtering function, such as an average, to the pixels from several different input pictures to create filtered pixels. Temporal filtering of video sequences generally falls into one of two categories, (1) motion compensated, and (2) non-motion compensated. For video sequences containing motion, motion compensated temporal-filtering methods generally outperform non-motion compensated temporal-filtering methods. Motion-compensated temporal filtering noise reduction methods generally require more computational effort than other noise reduction methods.

Thus, there is need for a technique for performing motion-compensated noise reduction during video decoding with reduced computational complexity.

### BRIEF SUMMARY OF THE INVENTION

Briefly, in accordance with a first aspect of the present principles, there is provided a method for encoding a video signal with reduced noise. The method commences by estimating the motion for each macroblock in the video signal N times (where N is an integer) to yield N sets of motion estimation data, each set including a reference picture index and a motion vector. Typically, although not necessarily, each set of motion estimation data makes use of a different reference picture. Each of the N sets of motion estimation data is used to generate a prediction, and the N predictions are used in a filtering operation to yield a noise-reduced macroblock. The noise-reduced macroblock is encoded, using the motion vector and reference picture index of the best one of the motion estimation data sets for that macroblock.

In accordance with a second aspect of the present principles, a video encoder includes a motion estimation stage, which performs both motion estimation and noise reduction. The encoder performs noise reduction for each macroblock using N sets of motion estimation data, each typically, although not necessarily, generated from a separate reference picture. The noise reduced macroblock is encoded, using the motion vector and reference index of the best of the motion estimation data sets for that macroblock.

### BRIEF DESCRIPTION OF THE DRAWINGS

FIG. 1 illustrates a block diagram of an exemplary video decoder in accordance with the prior art;

FIG. 2 illustrates a video encoder with an embedded noise reducer in accordance with a first aspect of the present principles;

FIG. 3 illustrates a flow chart depicting the process of video encoding, including the noise reduction method in accordance with the present principles;

FIG. 4 illustrates a flow chart depicting the process of noise reduction that occurs during the video encoding process of FIG. 3; and

FIG. 5 illustrates a video encoder with an embedded noise reducer and spatial filter in accordance with a second aspect of the present principles.

### DETAILED DESCRIPTION

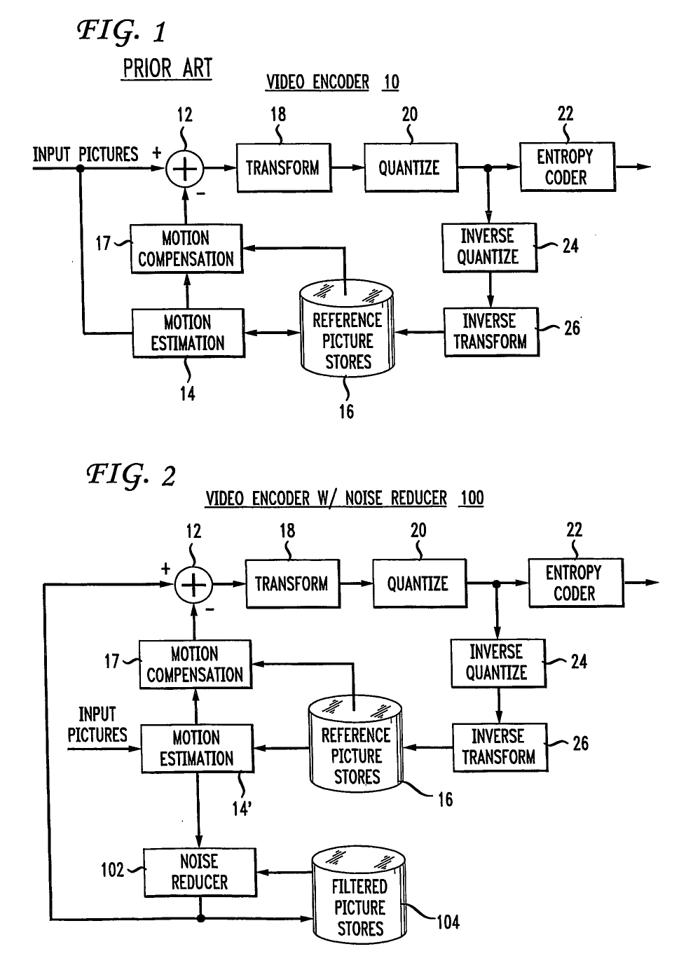

FIG. 1 illustrates prior art a video encoder 10 capable of practicing the H.264 compression technique, as well as similar compression techniques. The H.264 encoder 10 of FIG. 1 includes a summing block 12 supplied at its non-invert input with an input video stream. A motion estimation block 14 receives the input video stream along with a previously encoded reference picture stored in a reference picture store 16. For each macroblock in a current input picture appearing in the input video stream, the motion estimation block 14 compares the current macroblock with one or more reference pictures from the reference picture store 16.

The H.264 video compression system (also referred to as JVT or MPEG AVC) uses tree-structured hierarchical macroblock partitions. Inter-coded 16×16 pixel macroblocks can undergo division into macroblock partitions of sizes 16×8, 8×16, or 8×8. Macroblock partitions of 8×8 pixels, known as sub-macroblocks, can undergo further division into sub-macroblock partitions of sizes 8×4, 4×8, and 4×4. The motion estimation block 14 selects how to divide the macroblock into partitions and sub-macroblock partitions based on the characteristics of a particular macroblock in order to maximize compression efficiency and subjective quality. For each macroblock, the motion estimation block 14 will provide a macroblock mode, which indicates the breakdown of the macroblock into the various partitions sizes. In addition, the motion estimation block 14 provides a reference picture index and a motion vector for each macroblock.

The H.264 video compression standard permits the use of multiple reference pictures for inter-prediction, with a reference picture index coded to indicate the use of a particular one of the multiple reference pictures. In P pictures (or P slices), only single directional prediction is used, and the allowable reference pictures are managed in a first list, referred to as list 0. In B pictures (or B slices), two lists of reference pictures are managed, list 0 and list 1. In B pictures (or B slices), single directional prediction using either list 0 or list 1 is allowed. Bi-prediction using both list 0 and list 1 is also allowed. When bi-prediction is used, the list 0 and the list 1 predictors are averaged together to form a final predictor.

The motion estimation block 14 has considerable freedom to decide the best macroblock mode, reference picture indices and motion vectors for a macroblock, with the goal of creating a good predictor for the current picture to assure efficient encoding. Once the motion estimation block 14 makes these decisions during the motion estimation process, a motion compensation block 17 will receive the reference picture index, macroblock mode and motion vector from the motion estimation block. From such information, the motion compensation block 17 forms a predictor for subtraction from the input picture by the summing block 12 to create a difference picture. The difference picture undergoes a transform by way of a transform block 18. A quantizer 20 quantizes the transformed difference picture prior to input to an entropy coder 22, which yields a coded video picture at its output. An inverse quantizer 24 and an inverse transform block 26 perform inverse quantization and inverse transformation, respectively, on the difference picture to yield a reference picture for storage in the reference picture store 16 for use in the coding of later pictures.

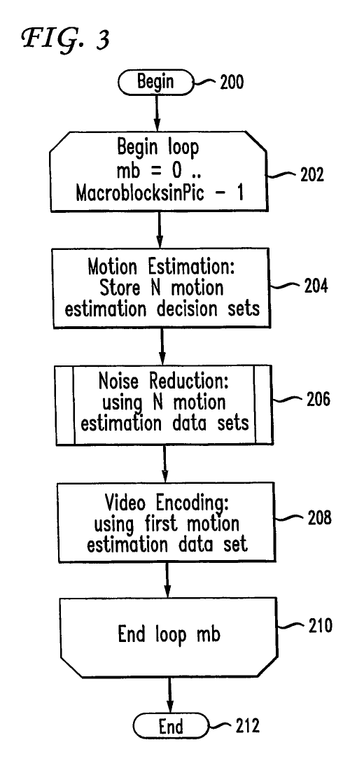

FIG. 2 illustrates a first preferred embodiment 100 of video encoder with noise reduction in accordance with the present principles. The encoder 100 shares many elements in common with the encoder 10 of FIG. 1 and like reference numerals identify like elements in both drawings. Similar to the prior art encoder 10 of FIG. 1, the encoder 100 of FIG. 2 includes a motion estimation block 14′ that receives both the input video stream and previous coded pictures from the reference picture store 16. However, the motion estimation block 14′ of FIG. 2 differs from the motion estimation block 14 of FIG. 1 in the following respect. As discussed previously, the motion estimation block 14 of FIG. 1 yields a single best macroblock mode for the macroblock, a reference picture index for the macroblock partition and motion vector for a macroblock partition or sub-macroblock partition. In contrast, the motion estimation block 14′ of the present principles provides at its output N sets of motion estimation data that each include a Macroblock Mode, Reference Picture Index (RefPicIndex), and Motion Vector (MV), for the partitions and sub-macroblock partitions of the macroblock.

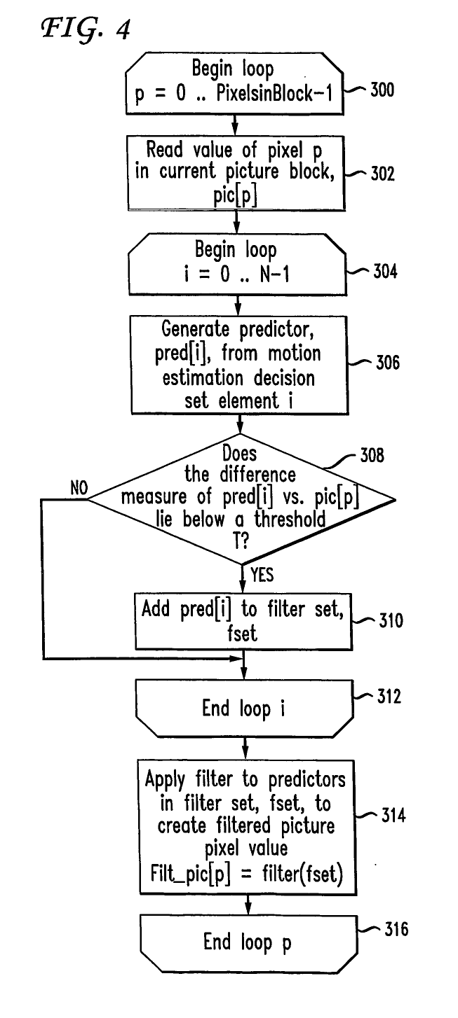

In accordance with the present principles, the motion estimation function performed by the video encoder of FIG. 2 facilitates noise reduction. A noise reducer 102 within the encoder 100 receives each of the N sets of motion estimation data from the motion estimation block 14′. As described hereinafter with respect to FIG. 4, the noise reducer 102 compares the current pixel with a predicted value received from the motion estimation block 14. If the difference between them is below a prescribed threshold, the predictor becomes part of a filtering set applied employed by the noise reducer 102 for pixel filtering. The result of such pixel filtering yields a filtered picture stored in a filtered picture store 104. Such filtered pictures become the input to the encoding process, i.e., the input to the summing amplifier 12.

FIG. 3 depicts in a flow chart the steps of the process practiced by the encoder 100 of FIG. 2 for reduced noise encoding each picture in the input video stream. The process begins during step 200 by initializing various variables, including a loop variable mb. Thereafter, step 202 occurs, and a loop processes begins. Thereafter, step 204 occurs during which motion estimation occurs for each macroblock, with each of the N motion estimation decision sets being computed and then stored. The noise reducer 102 of FIG. 2 then performs noise reduction on the macroblock, using the stored N motion estimation decision sets during step 206.

Video encoding of the macroblock occurs during step 208. First, the motion compensation block 17 of FIG. 2 creates a predictor for the macroblock using a best one of the N stored motion estimation decision sets, usually the first set which is considered to be the best of the sets. This prediction is subtracted from the filtered picture. The difference picture then undergoes transformation, quantization and entropy coding in the manner described with respect to FIG. 1. The difference picture also undergoes inverse quantization ed and inverse transformation prior to storage in the reference picture store 17 of FIG. 2. In one embodiment of the present invention, each of the N motion estimation data sets makes use of a different reference picture index. Following step 208, step 210 occurs at which point the loop process begun during step 202 ends once the loop variable mb equals the number of macroblocks.

Stated another way, steps 202-208 undergo repetition until the completion of encoding of all macroblocks in the picture. Thereafter, the encoding process ends during step 212.

As discussed previously, the N motion estimation decision sets serve as the input to the noise reducer 102 of FIG. 2. FIG. 4 depicts in flow chart form the steps of the noise reduction process performed by the noise reducer 102. The noise reduction process begins with step 300, whereupon a loop operation commences with each pixel looped through in accordance with a loop index p. During step 302, the value of each pixel p in a current picture block pic[p] is read. During step 304, a second loop operation commences, with each motion estimation decision set looped through in accordance with a loop variable i. During step 306, the motion compensation block 17 of FIG. 2 creates a predictor, pred[i], for the pixel p by performing motion compensation using the i-th motion estimation decision set. During step 308, a difference measure is made between the current pixel pic[p] with the predictor, pred[i].

The difference measure can include luma and/or chroma values in the calculation. As an example, the difference measure can be the absolute difference value. If the difference measure lies below a threshold, then during step 310, the predictor is added to a filtering set, fset, used in the noise reduction filtering operation performed by the noise reducer 102 of FIG. 2. Following step 310 (or step 308 when the difference measure lies above the threshold), then step 312 occurs, and the loop i operation ends. Stated another way, steps 304-310 undergo repletion until generation of a predictor for each motion estimation decision set, and a subsequent comparison of that predictor against a threshold value.

Following step 312, step 314 occurs and the filter obtained from the filter set fset created during step 310 is applied to the pixel p to create a filtered pixel value. The filtering operation occurs separately on luma samples and on associated samples of both chroma components. Any of several different filter functions can be used in the noise reduction filtering operation, such as computing an average, a weighted average, or a median. The filtering operation can also include spatial neighbors in the computation. The spatial neighbors can also be compared with a threshold to consider whether to include the spatial neighbors in the filtering operation. The Filtered Picture store 104 of FIG. 2 stores the result of the pixel filtering operation, as Filt_pic[p]. The filtered picture, Filt_pic then becomes the input to the rest of the video encoding process when noise reducing later pictures. Alternatively, the original input pictures of the reference picture stores can be used as inputs to the noise reduction process.

For macroblocks residing within intra (I) pictures (or I-slices), spatial-only filtering typically occurs. Alternatively, the motion estimation and noise reduction processes described earlier can occur, but with the video encoder performing intra-only encoding, and hence not making use of the motion estimation decision set chosen in the motion estimation decision set.

For the encoder 100, little additional complexity results from performing motion estimation on an I picture, as the existing motion estimation block 14′ already exist and would otherwise go unused under such conditions.

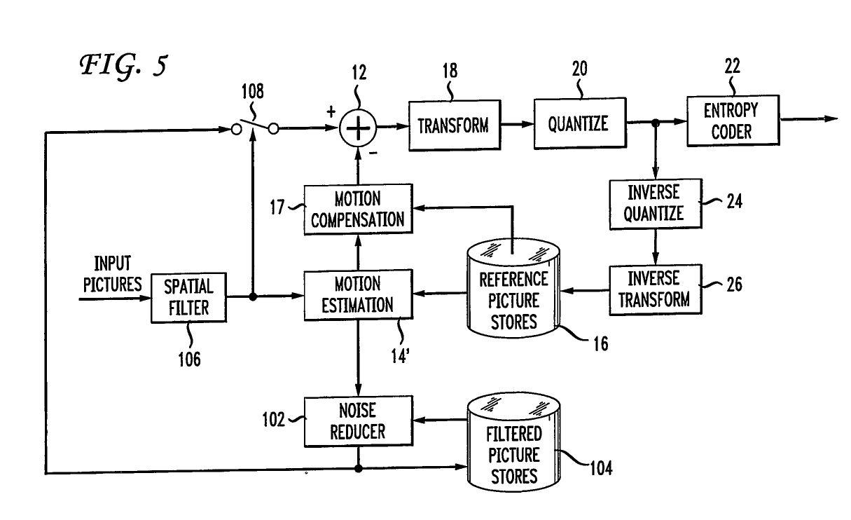

FIG. 5 depicts an alternate illustrative embodiment of an encoder 100′ in accordance with the present principles. The encoder 100′ of FIG. 5 shares many features in common with the encoder 100 of FIG. 2 and like reference numbers identify like elements.

However, unlike the encoder 100 of FIG. 2, the encoder 100′ of FIG. 5 includes a spatial filer 106 for filtering the input pictures prior to receipt at the motion estimation block 14′. For I pictures, motion estimation does not occur, and a switch 108 couples the output of the spatial filer 106 to the summing block 12. For P and B, pictures, motion estimation is performed using the spatially filtered input pictures as input. Under such circumstances, the switch 108 couples the non-invert input of the summing amplifier to receive the output of the noise reducer 102.

The foregoing describes an encoder with low complexity noise reduction suitable for any block-based motion compensation video compression technique. However, the encoder of the present principles affords the best results for a compression technique like H.264 that uses multiple reference pictures, because both the encoder and noise reducer can re-use the motion estimation function, allowing the use of multiple pictures used in the noise reduction filtering process. The incremental complexity of performing noise reduction as part of a video encoder is very small compared to that of a standalone video noise reduction system. For noisy video sequences, the encoder of the present principles can significantly improve the compressed video quality at a particular bit rate as compared to a normal video encoder.

1. A method for encoding a video signal with reduced noise, comprising the steps of:
estimating motion for each macroblock in an input video signal N times (where N is an integer) to yield N sets of motion estimation decision sets, each set including a reference picture index and motion vector;
creating, for each macroblock, a noise reduced macroblock using the N sets of motion estimation data; and
encoding each noise reduced macroblock using a best one of the motion estimation data sets.

2. The method according to claim 1 wherein the step of estimating motion further includes the step estimating the motion N times using each of N different reference pictures.

3. The method according to claim 1 wherein the step of creating the noise reduced macroblock further comprises the steps of:
selecting at least a plurality of the N sets of motion estimation decision sets; and
temporally filtering each pixel in the macroblock to using the selected motion estimation decision sets.

4. The method according to claim 3 wherein the selecting step further comprises the steps of:
generating a predictor for each motion estimation decision set;
calculating a difference between the predictor and the current pixel;
determining whether the difference is less than a threshold; and if so
selecting the motion estimation decision set whose difference is less than the threshold.

5. The method according to claim 1 further comprising the step of spatially filtering the input video prior to estimating motion.

6. A method for encoding a video signal with reduced noise, comprising the steps of:
estimating motion for each macroblock in an input video signal N times (where N is an integer) using each of N separate reference pictures to yield N sets of motion estimation decision sets, each set including a reference picture index and motion vector;
creating, for each macroblock, a noise reduced macroblock using the N sets of motion estimation data; and
encoding each noise reduced macroblock using the best one of the motion estimation data

7. A video encoder, comprising:
a motion estimation stage for estimating the motion in each macroblock of an input video signal N times (where N is an integer) to yield N sets of motion estimation decision sets, each set including a reference picture index and motion vector,
a noise reducer for creating a noise reduced macroblock using the N sets of motion estimation data;
encoding means for encoding the noise reduced macroblock.

8. The encoder according to claim 7 further including a reference picture store for storing coded pictures and where the motion estimation stage estimates the motion N times using each of N different stored reference pictures.

9. The encoder according to claim 7 further comprising:
a reference picture store for storing the coded pictures;
means for applying the stored previously coded pictures as input video stream to for estimating the motion for each macroblock to yield the N sets of motion estimation decision sets; while
means for applying the motion estimation decision sets to filter pictures for noise reduction.

10. The encoder according to claim 7 further comprising a spatial filter for spatially filtering the input video prior to performing motion estimation.
